(19) United States
(12) Patent Application Publication
(10) Pub. No.: US 2026/0178676 A1
(43) Pub. Date: Jun. 25, 2026

(54) SERVICE PROCESSING METHOD AND APPARATUS, AND COMPUTER DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Tianjiao LANG, Shenzhen (CN)

(21) Appl. No.: 19/463,856

(22) Filed: Jan. 29, 2026

Related U.S. Application Data
(63) Continuation of application No. PCT/CN2024/113268, filed on Aug. 20, 2024.

(30) Foreign Application Priority Data
Oct. 20, 2023 (CN) 202311363503.0

(51) Int. Cl. G06F 16/9535; G06Q 10/067; G06Q 10/087; G06Q 10/10; G06Q 30/0601

(52) U.S. Cl. CPC G06F 16/9535; G06Q 10/067; G06Q 10/087; G06Q 10/10; G06Q 30/0631

(57) ABSTRACT

A service processing method executed by a computer device includes acquiring prompt information of a target item recalled for a service user; calling an item processing model under a model application inference framework to predict a degree of association of the service user with the target item based on the prompt information of the target item, the item processing model being obtained by training under a model training inference framework and reused in the model application inference framework, and a processing speed of the item processing model in the model application inference framework being higher than a processing speed of the item processing model in the model training inference framework; and performing service processing on the target item based on the degree of association of the service user with the target item.

### RELATED APPLICATIONS

This application is a continuation of PCT Application No. PCT/CN2024/113268, filed on Aug. 20, 2024, which claims priority to Chinese Patent Application No. 2023113635030, entitled “SERVICE PROCESSING METHOD AND APPARATUS, AND Computer Device, Storage Medium, and Program Product” Filed on Oct. 20, 2023, which are both incorporated by reference in their entirety.

### FIELD OF THE TECHNOLOGY

This application relates to the technical field of computers, particularly relates to the technical field of artificial intelligence, and specifically relates to a service processing method and apparatus, and a computer device, a storage medium, and a program product.

### BACKGROUND OF THE DISCLOSURE

Generally, when a service user accesses a service, the service provider can perform service processing. The service processing can specifically refer to recommending items with a high degree of association to the service user for the service user, namely, the service provider can recommend items to the service user making the service access. At present, the service provider can use artificial intelligence models (e.g., recommendation models) for service processing. However, these artificial intelligence models usually have a large number of model parameters, so the inference speed of the artificial intelligence model is slow, resulting in low service processing efficiency.

### SUMMARY

Embodiments of this application provide a service processing method and apparatus, and a computer device, a storage medium, and a program product.

On aspect of this application provides a service processing method executed by the computer device, including acquiring prompt information of a target item recalled for a service user, the prompt information of the target item comprising information of the service user, features of at least one associated item associated with the service user, and features of the target item; calling an item processing model under a model application inference framework to predict a degree of association of the service user with the target item based on the prompt information of the target item, the item processing model being obtained by training under a model training inference framework and reused in the model application inference framework, and a processing speed of the item processing model in the model application inference framework being higher than a processing speed of the item processing model in the model training inference framework; and performing service processing on the target item based on the degree of association of the service user with the target item.

Correspondingly, an embodiment of this application further provides the computer device, which includes a processor, adapted to implement computer programs; and a computer-readable storage medium, having computer programs stored therein, the computer programs being adapted to be loaded and executed by the processor to implement the above-mentioned service processing method.

Correspondingly, an embodiment of this application provides a non-transitory computer-readable storage medium having computer programs stored therein, the computer programs, when read and executed by the processor of the computer device, causing the computer device to perform the above-mentioned service processing method.

The details of one or more embodiments of this application will be provided in the accompanying drawings and descriptions below. Other features, objectives, and advantages of this application become apparent from the description, the accompanying drawings, and the claims.

### BRIEF DESCRIPTION OF THE DRAWINGS

In order to provide a clearer explanation of embodiments of this application or the technical solutions in conventional technology, a brief introduction will be given to the accompanying drawings required in the description of the embodiments or conventional technology. Clearly, the accompanying drawings in the following description are only some embodiments of this application. For those of ordinary of skill in the art, other accompanying drawings can be obtained based on these accompanying drawings without any creative effort.

FIG. 1 is a schematic architectural diagram of a service processing system provided by an embodiment of this application.

FIG. 2 is a schematic diagram of a training process and a testing process of an item processing model provided by an embodiment of this application.

FIG. 3 is a flowchart of a service processing method provided by an embodiment of this application.

FIG. 4 is a schematic diagram of a training process of an item processing model provided by an embodiment of this application.

FIG. 5 is a schematic structural diagram of an item processing model before modification under a model application inference framework provided by an embodiment of this application.

FIG. 6 is a schematic structural diagram of an item processing model after modification under a model application inference framework provided by an embodiment of this application.

FIG. 7 is a flowchart of another item processing method provided by an embodiment of this application.

FIG. 8 is a schematic diagram of a concurrent mechanism provided by an embodiment of this application.

FIG. 9 is a schematic diagram of another concurrent mechanism provided by an embodiment of this application.

FIG. 10 is a schematic diagram of yet another concurrency mechanism provided by an embodiment of this application.

FIG. 11 is a schematic structural diagram of a service processing apparatus provided by an embodiment of this application.

FIG. 12 is a schematic structural diagram of a computer device provided by an embodiment of this application.

### DESCRIPTION OF EMBODIMENTS

The following clearly and completely describes the technical solutions in one embodiments of this application with reference to the accompanying drawings in one embodiments of this application. Apparently, the described embodiments are some of the embodiments of this application rather than all of the embodiments. Based on the embodiments in this application, all the other embodiments obtained by a person of ordinary skill in the art without making any inventive effort fall within the scope of protection of this application.

The embodiments of this application involve service. The service may specifically refer to an item recommendation service, and the service processing logic of the item recommendation service is to recommend candidate items with a high degree of association to a service user for the service user from a plurality of candidate items recalled for the service user when the service user makes service access. The items referred to in one embodiments of this application may include, but are not limited to, any of the following: electronic goods (e.g., smart retail goods and e-commerce goods) and media information (e.g., video, audio, images, items, and URLs), etc.

A service provider may use an artificial intelligence model to perform service processing. Specifically, the service provider may use the artificial intelligence model to perform the association prediction on the service user and candidate items recalled for the service user, to obtain a degree of association of the service user with the candidate items. Therefore, it can recommend the candidate item with a high degree of association to the service user for the service user based on the degree of association of the service user with the candidate item.

Currently, in the field of artificial intelligence, with the popularity of ChatGPT (Chat Generative Pre-trained Transformer), more and more large-scale generative language models (Large Language Models) are emerging. The embodiments of this application do not limit the type of large-scale generative language models. The large-scale generative language model is a generative language model with an Encoder-Decoder framework as the model framework, an Encoder-only framework or a Decoder-only framework. The Encoder-Decoder framework is a very common model framework in deep learning, and one of the most notable features is that it is an End-to-End learning algorithm, which is also called Sequence to Sequence Learning. The encoding refers to the transformation of an input sequence into a vector with fixed length, and the decoding refers to the transformation of the previously generated fixed vector into an output sequence. The Encoder-only framework means that the model has the function of encoding. The Decoder-only framework means that the model has the function of decoding. In one embodiments of this application, the large-scale generative language model is illustrated by taking as an example a generative language model with the Encoder-Decoder framework as the model framework, for example, the large-scale generative language model may be an MT5model with the Encoder-Decoder framework as the model framework. The MT5 model is a multi-language natural language processing model with a Transformer model architecture and has been pre-trained in a large multi-language corpus. The Transformer model is a natural language processing model. It can learn contextual semantics of each token according to the relationship between each token in the input sequence. The Transformer model can achieve a good semantic learning effect based on the Encoder-Decoder framework and an Attention mechanism. The biggest advantage of the Transformer model is that it can perform parallelizing efficiently. Tokens are constituent elements of an input sequence, which can decompose an input sequence such as a sentence, a paragraph, and an article into data structures in units of tokens into the large-scale generative language model.

How to apply the large-scale generative language model as an item processing model to the item recommendation service has become a current research hotspot. However, the large-scale generative language model is currently unable to meet the item recommendation needs of the item recommendation service. Specifically: (1) the large-scale generative language model has a large number of model parameters, so its model inference speed is slow, the model inference delay is high, and the model inference performance limits the implementation of the large-scale generative language model in real-time item recommendation services, which cannot meet the real-time recommendation and parallel inference needs of the item recommendation services; (2) the tokens generated by the large-scale generative language model cannot meet the recommendation scoring and ranking requirements of the item recommendation services; based on (1) and (2), it can be seen that the large-scale generative language model cannot be applied to the item recommendation services as the item processing model.

For the problem of poor inference performance of the large-scale generative language model (namely, the large-scale generative language model cannot meet the real-time recommendation needs of the item recommendation services), in the industry, it has proposed the following three solutions: the first solution is to perform model compression or model distillation to reduce model parameters of the large-scale generative language model to increase the model inference speed at the expense of model accuracy; the second solution is to slightly adjust the pre-trained model and exit the inference in advance according to a set threshold to reduce the number of model network layers; and the third solution is to cache intermediate results of a decoder module in the large-scale generative language model to improve the model inference speed. However, in the practice of the item recommendation services, the above three solutions are not advisable; in the first solution and the second solution, it is not advisable to improve the inference speed at the expense of the accuracy of results for real-time item recommendation application, because the effect of the large-scale generative language models in real-time item recommendation scenarios cannot be guaranteed after sacrificing the accuracy of results, which may reduce the estimated AUC value more; the estimated AUC is a model evaluation index, which can be configured for evaluating binary models; the higher the estimated AUC value, the higher the accuracy of model classification, the lower the estimated AUC value, and the lower the accuracy of model classification. For the third solution, it is necessary to increase internal memory cache, which cannot improve the model inference speed of the large-scale generative language models when resources are limited.

Based on this, an embodiment of this application provides a service processing method; for the problem of poor inference performance of the large-scale generative language models (namely, the large-scale generative language models cannot meet the real-time recommendation needs of the item recommendation services), the service processing method provides a solution of separating a training framework and an inference framework of the large-scale generative language model; a processing speed of the large-scale generative language model under the inference framework is higher than a processing speed of the large-scale generative language model under the training framework; in a model inference stage of the large-scale generative language model, an inference acceleration framework that can improve the model processing speed is used, and it does not sacrifices the model accuracy of the large-scale generative language model; and therefore, the model inference speed of the large-scale generative language models is improved while ensuring the model effect, thereby improving the service processing efficiency.

For the problem that the large-scale generative language model cannot meet recommendation scoring and sorting requirements of the item recommendation service, the service processing method provides a solution of optimizing and modifying a decoder of the large-scale generative language model; the optimized and modified large-scale generative language model can score the candidate items, namely, the optimized and modified large-scale generative language model can output the degree of association of the service user with the candidate items, and treat the degree of association of the service user with the candidate items as a score of the candidate items, and then rank and recommend the candidate items, thus the large-scale generative language model can adapt to the item recommendation service and is successfully applied to the item recommendation service as the item processing model.

In one embodiments of this application, the type of the training framework used by the large-scale generative language model (namely the item processing model) is not limited, for example, the training framework may be a pytorch framework. Similarly, in one embodiments of this application, the type of the inference framework used by the large-scale generative language model (namely the item processing model) is not limited, the inference framework may be any inference acceleration framework that can improve the processing speed of the large-scale generative language model (namely the item processing model). For example, the inference framework may be an inference acceleration framework of Faster-Transformer. The Faster-Transformer is a performance optimization solution proposed for Transformer model inference, and the Faster-Transformer is written with c++ and cuda and depends on a highly optimized cuBLAS; and c++ (c plus plus) is an advanced computer programming language, compute unified Device architecture (cuda) is a universal parallel computing architecture, and CUDA Basic Linear Algebra Subroutine Library (cuBLAS) is a basic linear algebra subroutine library of cuda. Namely, in one embodiment of this application, the item recommendation service can be adapted under the pytorch framework to finely adjust the large-scale generative language model (namely the item processing model); in the model inference stage, in order to improve the model inference speed, the inference acceleration framework based on Faster-Transformer can be adopted, the finely adjusted large-scale generative language model (namely the item processing model) is reused, and the decoder of the large-scale generative language model (namely the item processing model) is optimized under the inference acceleration framework to output scores.

In addition, the service processing method provided by one embodiment of this application may be combined with a cloud technology, for example, cloud computing in the cloud technology can further improve the model inference speed of the large-scale generative language model (namely the item processing model) in the service processing method by a distributed computing mode. The cloud technology refers to a hosting technology that unifies a series of resources such as hardware, software and a network in a wide area network or a local area network to realize data computing, storage, processing and sharing; the cloud technology is a general term of a network technology, an information technology, an integration technology, a management platform technology, an application technology and the like applied based on a cloud computing service mode, and may form a resource pool and used as required, and is flexible and convenient. The cloud computing is a computing mode, which distributes computing tasks on the resource pool formed by a large number of computers, so that various application systems can acquire computing power, storage space and information services according to needs. The network providing resources is referred to as “cloud”, and the resources in the “cloud” are infinitely expanded in user's perspective, can be acquired at any time, used as required, expanded at any time and paid according to use.

A service processing system provided by an embodiment of this application is described below in combination with the accompanying drawing. The service processing system can be adapted to implement the service processing method provided by the embodiments of this application.

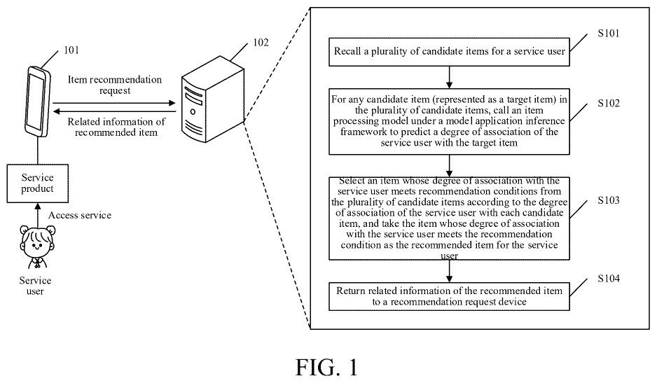

As shown in FIG. 1, the service processing system may include a recommendation request device 101 and an item recommendation device 102. In one embodiment of this application, a mode of connection between the recommendation request device 101 and the item recommendation device 102 is not limited, and direct communication may be established between the recommendation request device 101 and the item recommendation device 102 in a wired communication mode, or, indirect communication may be established between the recommendation request device 101 and the item recommendation device 102 in a wireless communication mode.
(1) Recommendation request device 101:

The recommendation request device 101 may be a device used by the service user, service products corresponding to services can run in the recommendation request device 101, and the service user can access the service through the service product running in the recommendation request device 101; and the service access may be understood as the service user logging in service, the service user browsing service content or the service user executing service operation and the like. In one embodiment of this application, the type of the service products is not limited, and the service products may be a service application, a service applet, a service browser, a service website and the like. The recommendation request device 101 can be configured to initiate an item recommendation request to the item recommendation device 102, and the item recommendation request can be configured for requesting to recommend an item with a high degree of association to the service user for the service user. The item recommendation request may be generated when the service user accesses the service. For example, the item recommendation request may be generated when the service user logs in the service. For another example, the item recommendation request may be generated when the service user browses the service content. For yet another example, the item recommendation request can be generated when the service user executes the service operation (such as the item recommendation operation and the operation of accessing items in the service). The recommendation request device 101 may also display related information (such as item name, item title, item picture, item video and item price) of the recommended item to the service user.
(2) Item recommendation device 102:

The item recommendation device 102 can be configured to recommend items with a high degree of association to the service user for the service user. Specifically: S101, the item recommendation device 102 can recall a plurality of candidate items for the service user in response to the item recommendation request sent by the recommendation request device 101; S102, for any candidate item (which may be referred to as a target item) in the plurality of candidate items, the item recommendation device 102 can call the item processing model under a model application inference framework (the model application inference framework refers to the above-mentioned inference framework) to predict the degree of association of the service user with the candidate items; S103, after the degree of association of the service user with each candidate item is obtained, the item recommendation device 102 can select an item with a high degree of association to the service user from the plurality of candidate items according to the degree of association of service user with each candidate item, and take the item whose degree of association with the service user meets the recommendation condition as the recommended item for the service user; and S104, related information of the recommended item is returned to the recommendation request device 101. The degree of association meeting the recommendation conditions may be the degree of association being greater than or equal to a preset threshold, or after descending according to the degree of association, its rank number being smaller than or equal to a preset rank number.

For the item recommendation device 102, before the item processing model formally carries out item recommendation online, the item processing model needs to undergo a model training stage and a model test stage, and after the item processing model passes the model test, it can perform item recommendation formally online.

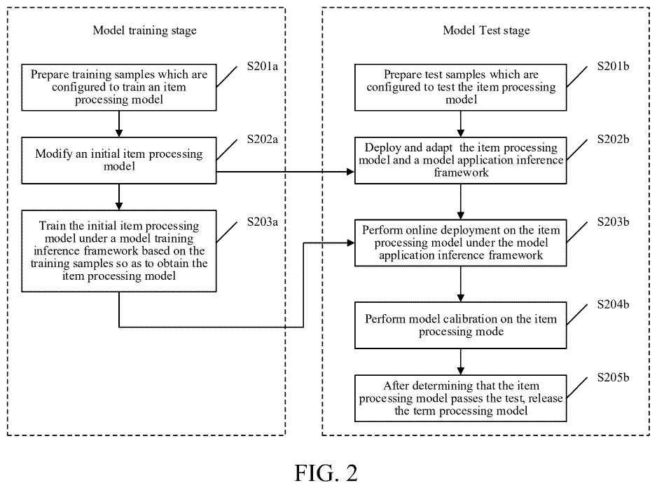

As shown in FIG. 2, in the model training stage: S201a, training samples can be prepared for training the item processing model; S202a, an initial item processing model can be modified to adapt to the item recommendation service to enable the initial item processing model to score items; S203a, the initial item processing model can be trained under the model training inference framework (the model training inference framework refers to the above-mentioned training framework) based on the training samples to obtain the item processing model.

As shown in FIG. 2, in a model test stage: S201b, test samples can be prepared for testing the item processing model; S202b, the item processing model can be deployed and adapted to the model application inference framework the deployment adaptation refers to modifying the item processing model under the model application inference framework to enable the item processing model under the model application inference framework to score items, to adapt to the item recommendation service, which is similar to the model training stage; S203b, online deployment is performed on the item processing model under the model application inference framework, specifically, after the item processing model is deployed and adapted to the model application inference framework, a framework c++ code can be compiled to obtain a lib file (a static data link library), online deployment refers to deploying an online model inference service according to the compiled lib file in combination with a model inference code, and during deployment, it is essential to ensure consistency in the version of compilation environment such as cuda version and gcc (a compiler); and S204b, model calibration is performed on the item processing model, because frameworks adopted in the model training stage and the model inference stage are different, it is needed to perform model calibration, and the model calibration refers to evaluating the item processing model under the model training inference framework (e.g., pytorch framework) used in the model training stage and the model application inference framework (e.g., Faster-Transformer framework) used in the model inference stage based on the same batch of test samples; and if a difference between the evaluation results (specifically, the evaluation results may refer to estimated AUC values) of the item processing model under the two frameworks is smaller than the threshold thres (the threshold thres can be set according to an empirical value, for example, the threshold thres may generally be 0.00001), it can be determined that the item processing model passes the test; and S205b, after determining that the item processing model passes the test, the item processing model can be released, accessing online real traffic, and the item processing model is called under the model application inference framework for item recommendation.

The recommendation request device 101 may be a terminal, and the item recommendation device 102 may be a terminal or a server. The terminal in one embodiment of this application may include, but is not limited to, any one of a smart phone, a tablet computer, a notebook computer, a desktop computer, a smart watch, a smart home appliance, a smart voice interaction device, a vehicle-mounted terminal and an aircraft. The server mentioned in one embodiment of this application may be a separate physical server, or a server cluster composed of a plurality of physical servers or a distributed system, or a cloud server providing basic cloud computing services such as cloud services, cloud databases, cloud computing, cloud functions, cloud storage, Network services, cloud communication, middleware services, domain name services, security services, content delivery network (CDN), big data and artificial intelligence platforms, which is not limited in one embodiment of this application. In addition, the service processing system shown in FIG. 1 is illustrated by taking the recommendation request device 101 and the item recommendation device 102 being integrated in different devices as an example, the recommendation request device 101 and the item recommendation device 102 may also be integrated in the same device. For example, the recommendation request device 101 and the item recommendation device 102 may be integrated in the same terminal, and in the same terminal, the recommendation request device 101 may be understood as a front end of the terminal, and the item recommendation device 102 may be understood as a background service of the terminal.

The service processing system provided by the embodiment shown in FIG. 1 is to more clearly describe the technical solution of one embodiment of this application, and does not constitute a limitation on the technical solution provided by one embodiment of this application, a person of ordinary skill in the art can know that with the evolution of system architecture and the emergence of new service scenarios, the technical solutions provided by one embodiment of this application are also applicable to similar technical problems. In addition, the relevant data collection and processing (e.g., collecting information of a service user) in example application shall strictly follow the requirements of relevant laws and regulations and performed with the informed consent or separate consent of the personal information subject, and subsequent data use and processing are performed within the scope of laws and regulations and the authorization of the personal information subject.

Based on the above description of the service processing method and the service processing system, the specific application of the service processing method provided by one embodiment of this application is described below.

From the perspective of type of items in the service, the service processing method provided by one embodiment of this application may be applied to smart retail, e-commerce recommendation, information flow recommendation and other services. Specifically, in the smart retail service, items recommended to service users may be, for example, smart retail products, a degree of association of the service users to each smart retail product recalled for the service users can be analyzed, and smart retail products with a high degree of association to the service users can be recommended for the service users based on the relationship between the service users and each smart retail product. In the e-commerce recommendation scenario, items recommended to the service users may be, for example, e-commerce products, a degree of association of the service users to each e-commerce product recalled for the service users can be analyzed, and the e-commerce products with a high degree of association to the service users can be recommended for the service users based on the relationship between the service users and each e-commerce product. In the information flow recommendation service, items recommended to the service users may be, for example, video, audio, images, articles and other media information, a degree of association of the service users to each piece of media information recalled for the service users can be analyzed, and media information with a high degree of association to the service users can be recommended for the service users based on the relationship between the service users and each piece of media information.

From the perspective of service complexity, the service processing method provided by one embodiment of this application can be applied to simple service with relatively sparse data (for example, few items in the service, less related information of the items in the service) and a relatively poor recommendation effect of a traditional ranking recommendation model. The service processing method provided by one embodiment of this application may also be applied to complex services involving a plurality of service scenarios or a plurality of interfaces. The plurality of service scenarios may be understood as that there are a plurality of service scenarios in the service at the same time, item recommendation can be performed on the service users in the plurality of service scenarios. For example, the services may include an e-commerce recommendation service scenario and an information flow recommendation service scenario, e-commerce product recommendation can be performed on the service user in the e-commerce recommendation service scenario, information flow recommendation can be performed on the service user in the information flow recommendation service scenario, and item recommendation can be performed in parallel in the plurality of service scenarios. The plurality of interfaces may be understood as that a plurality of sub-services are integrated in the service through different interfaces, item recommendation can be performed on the service users in each sub-service, and the sub-service services of the sub-services can perform item recommendation in parallel; or the plurality of interfaces may be understood as that a plurality of service users access the service through different interfaces, item recommendation can be performed on each service user, and item recommendation can be performed in parallel on each service user, for example, at least 5 service users can access the service at the same time. Based on the same model effect, the time consumed by the inference acceleration framework used in one embodiment of this application can be reduced by 5 times compared with that of native framework inference.

In one embodiment of this application, rich language knowledge in the natural language model can used for slightly adjusting the item recommendation service, thereby improving the learning ability of the large-scale generative language model for the item recommendation scenario; and in one embodiment of this application, it supports high-concurrency inference, allows to access a plurality of service scenarios, a plurality of sub-services or a plurality of service users, thereby breaking through performance bottleneck, promoting the implementation of the large-scale generative language model in the industry.

The service processing method provided by one embodiment of this application is detailed below in cooperation with the accompanying drawings.

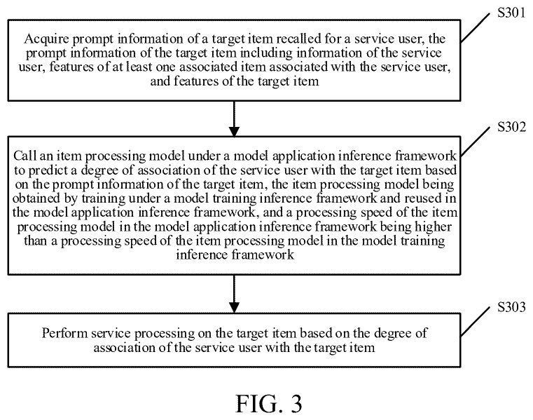

An embodiment of this application provides a service processing method, and the service processing method introduces modification of the item processing model for adapting to a service (i.e., the item recommendation service) in the model training stage and the model inference stage. The service processing method may be executed by the computer device, and the computer device may be, for example, the item recommendation device 102 in the service processing system shown in FIG. 1, or the computer device may be an integrated device of the recommendation request device 101 and the item recommendation device 102. As shown in FIG. 3, the service processing method may include, but is not limited to, the following operations S301-S303:

S301: Acquire prompt information of a target item recalled for a service user, the prompt information of the target item including information of the service user, features of at least one associated item associated with the service user, and features of the target item.

In a service (namely an item recommendation service) provided by the service provider, when the service user accesses the service, the service provider can recall a plurality of candidate items for the service user, it is needed to analyze a degree of association of service user to each candidate item by an item processing model, then a recommended item recommended for the service user can be selected from the plurality of candidate items based on the degree of association of service user to each candidate item, and item recommendation is performed on the service user according to the recommended item. In order to conveniently understand the process of analyzing the degree of association of service user with each candidate item, any candidate item (any candidate item may be referred to as the target item) in the plurality of candidate items is taken as an example to describe the process of analyzing the degree of association of the service user with the target item.

Specifically, the degree of association of the service user with the target item is analyzed based on the prompt information of the target item, the prompt information of the target item serves as input information of the item processing model, the prompt information of the target item can be acquired, and the prompt information of the target item may include the information of the service user, the features of at least one associated item associated with the service user, and the features of the target item. The at least one associated item associated with the service user refers to a historical item which is historically accessed by the service user in the service, and the features of the item (including the associated item, the target item or the candidate item) refer to information representing characteristics of the item.

Different from the input information of a traditional recommendation model, the item processing model belongs to a generative language model, the input information (namely prompt information) of the item processing model is composed of natural language, and the prompt information of the target item can be configured for inquiring whether the service user will access the target item under the condition that the service user historically accesses associated items. The analysis principle of the item processing model is: by understanding semantics of the prompt information of the target item, analyzing a similarity relationship between the features of the target item and the features of at least one associated item, analyzing the association relationship between the features of the target item and the information of the service user, generating a predicted associated label (answer) between the service user and the target item and a degree of association under the predicted associated label, where the predicted associated label can be configured for representing the willingness of the service user to access the target item (for example, the intention is yes (namely, the service user will access the target item) or the willingness is no (namely, the service user will not access the target item)), and the degree of association can be configured for representing the probability that the service user accesses the target item under a corresponding predicted associated label, and it can be used as a basis for ranking the target item.

The prompt information of all candidate items recalled for the service users has the same construction mode, and the construction mode of the prompt information of the target item will be described herein. Firstly, an item identifier sequence (item1, item2, . . . , itemn) of the associated items historically accessed by the service users, an item identifier (now_click_item) of the target item, and information of the service user can be acquired from a data center; the item identifier can be configured for uniquely identifying a corresponding item; the access operation of the service user to the associated item in the service at least may include a click browsing operation and a buy operation. Therefore, the item identifier sequence of the associated items historically accessed by the service user may include a click identifier sequence (click_item1, click_item2, . . . , click_itemn) of the associated items historically clicked by the service user, and a buy identifier sequence (buy_item1, buy_item2, . . . , buy_itemn) of the associated items historically bought by the service user; the information of the service user at least may include an identifier of the service user and a feature of the service user; the identifier of the service user can be configured for uniquely identifying the service user, and the feature of the service user refers to information representing characteristics of the service user. Then, the features of the associated items historically accessed by the service user can be acquired from the material repository according to the item identifier sequence (item1, item2, . . . , itemn) of the associated items historically accessed by the service user, and the features of the target item can be acquired from the material repository according to the item identifier (now_click_item) of the target item; taking the feature of the item being an item title as an example, the features of the associated item historically accessed by the service user may include a click title sequence (title1, title2, title3, . . . , titlen) of the associated items clicked by the service user and a buy title sequence (buy_title1, buy_title2, . . . , buy_titlen) of the associated items bought by the service user; and taking the feature of the item being an item title as an example, the feature of the target item is the title of the target item (now_click_title). Based on this, the constructed prompt information of the target item may include any one of the following:
(1) Basic prompt information: the basic prompt information may include the identifier of the service user, the features of the associated items historically accessed by the service user, and the features of the target item; and the basic prompt information can be configured for inquiring whether the service user will access the target item under the condition that the service user historically accesses the associated items. For example, the basic prompt information may be represented as follows: the service user has clicked on the associated items:
   [title1], [title2], [title3], . . . , [titlen], and then whether the service user will click the target item [now_click_title].
(2) Prompt information containing a time limit feature: the prompt information containing the time limit feature may include the identifier of the service user, the features of the associated items accessed by the service user in different historical time periods, and the features of the target item; and the prompt information containing the time limit feature can be configured for inquiring whether the service user will access the target item under the condition that the service user has accessed the corresponding associated item in different historical time periods. For example, the prompt information containing the time limit feature may be represented as follows: the service user has clicked on the associated items: [title1], [title2], [title3], . . . , [titlen], and has recently clicked on the associated items: [title1], [title2], . . . , and then whether the service user will click the target item [now_click_title].
(3) Prompt information containing time limit feature+feature of service user: the prompt information containing time limit feature+feature of service user may include the feature of the service user, the features of the associated items accessed by the service user in different historical time periods, and the feature of the target item; and the prompt information containing time limit feature+feature of service user can be configured for inquiring whether the service user with the feature will access the target item under the condition that the service user with the feature has accessed the corresponding associated items in different historical time periods. For example, the prompt information containing time limit feature+feature of service user can be represented as follows: the service user with [feature 1], [feature 2], . . . , clicks the associated items [title1], [title2], [title3], . . . , [titlen] in the past, and recently clicks the associated items [title1], [title2], etc., and then whether the service user clicks the target item [now_click_title] or not.
(4) Prompt information containing time limit feature+feature of service user+access feature: the prompt information containing time limit feature+feature of service user+access feature may include the features of the service users, the features of the associated items accessed by the service users in different historical time periods and under different access operations, and the feature of the target item; and the prompt information containing time limit feature+feature of service user+access feature can be configured for inquiring whether the service user having the feature of the service user accesses the target item under the condition that the service user has accessed the corresponding associated items in different historical time periods and under different access operations. For example, the prompt information containing time limit feature+feature of service user+access feature can be represented as follows: the service user with [feature of service user 1], [feature of service user 2], . . . , has clicked on the associated items [title1], [title2], [title3], . . . , [titlen], and has recently bought the associated items [title1], [title2], etc., and then whether the service user will click the target items [now_click_title].

In an item recommendation process, the candidate items may be provided with the prompt information in any one of the above four forms; or in the item recommendation process, the candidate item may be provided with the prompt information in a target form. The target form is a form which is selected from the above four forms in the model calibration link and enables the model to have a good inference effect (for example, high inference accuracy), which is conducive to improving the item recommendation accuracy, and improving the service processing accuracy.

S302: Call an item processing model under a model application inference framework to predict a degree of association of the service user with the target item based on the prompt information of the target item, the item processing model being obtained by training under a model training inference framework and reused in the model application inference framework, and a processing speed of the item processing model in the model application inference framework being higher than a processing speed of the item processing model in the model training inference framework.

The model application inference framework is an inference framework used by the item processing model in the application stage, and the inference framework is a technical framework configured for predicting the trained algorithm model. The model training inference framework is an inference framework used by the item processing model in the training stage. The degree of association of the service user with the target item represents the degree of association of the service user with the target item.

After the prompt information of the target item is acquired, the item processing model can be called under the model application inference framework, and based on the prompt information of the target item, association prediction is performed on the service user with the target item to obtain the degree of association of the service user with the target item. The item processing model is obtained by training under the model training inference framework and reused in the model application inference framework, namely, the training framework adopted by the item processing model in the training process is the model training inference framework, and the inference framework adopted by the item processing model in the inference process is the model application inference framework; and the processing speed of the item processing model in the model application inference framework is higher than the processing speed of the item processing model in the model training inference framework.

The item processing model is a large-scale generative language model based on a Transformer Encoder-Decoder architecture, the model required for the item recommendation service is a classification model, and the item recommendation service needs the item processing model to output the probability of whether the service user accesses the candidate items (namely, it is needed to output the degree of association of the service user to the candidate item), and therefore, in one embodiment of this application, the item processing model is modified, and an original large-scale generative language model is modified into the classification model adapting to the item recommendation service. In one embodiment of this application, the training framework used in the training process of the item processing model is different from the inference framework used in the inference process of the item processing model, so the item processing model is adaptively modified in the training framework and the inference framework in one embodiment of this application, and the adaptive modification for the item processing model in the training process and the adaptive modification for the item processing model in the inference process are correspondingly described below.
(1) Training process of item processing model:

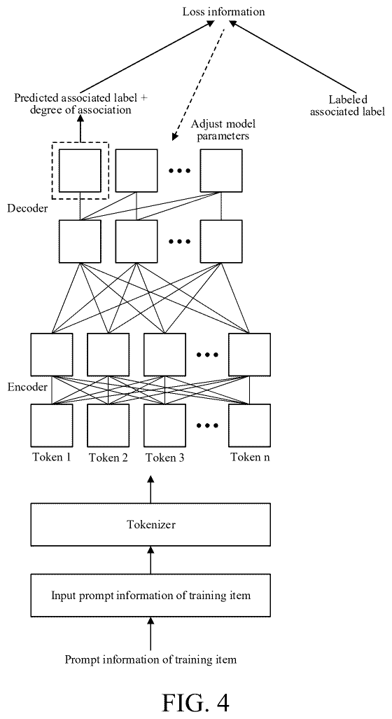

The item processing model may be a model obtained by pre-training in the large-scale multi-language corpus, and the training for the item processing model in one embodiment of this application may be understood as fine adjustment for the item processing model. As shown in FIG. 4, in the process of training the item processing model, the item processing model may include an encoder and a decoder, the encoder can be configured to encode the input information of the item processing model, and the decoder can be configured to decode encoder outputs of the encoder to generate a predicted associated label. The adaptive modification for the item processing model in the training process may include: in one embodiment of this application the decoder of the item processing model is modified to modify the original generative language model into the classification model matched with the item recommendation service, the original decoder outputs a token of the current round (namely predicted associated label) ; and in one embodiment of this application, the decoder is modified, a probability prediction module (softmax) is added, and a probability value (namely a degree of association under the predicted associated label) of the estimated token is outputted through the probability prediction module (softmax).

By adaptive modification, the process of training the item processing model may include: acquiring an initial processing model (namely the above-mentioned initial item processing model) and sample data, where the sample data may include a training set for training the initial processing model, the training set may include a plurality of training samples, each training sample may include prompt information (prompt) of the training item and a labeled associated label (original sample label or answer) corresponding to the training item, and the initial processing model can be trained based on the training set under the model inference framework to obtain the item processing model.

More specifically, the process of training the item processing model is iteratively performed, and the iteration may be understood as follows: a first training sample is adopted to perform first training on the initial processing model, a second training sample is adopted to perform second training on the item processing model obtained in the first training, and so on until a training termination condition is reached, and the item processing model which reaches the training termination condition is treated as the item processing model obtained in final training. Any training process in the iterative training process may include: inputting the prompt information (which may be referred to as the sample prompt) of the training item in the training sample into the item processing model, and dividing the prompt information of the training item into a plurality of tokens (token 1 to token n shown in FIG. 4) through a tokenizing module (tokenizer); outputting context semantic information (embedding) of each token in the prompt information of the training item by the encoder of the item processing model, and then generating an estimated token (namely a predicted associated label) and a token probability (namely the degree of association under the predicted associated label) through the Decoder; and then, computing loss information (loss) according to the estimated token (namely the predicted associated label), the labeled associated label of the training item and the token probability (namely the degree of association under the predicted associated label); in one embodiment of this application, the type of loss functions adopted for computing the loss information is not limited, for example, the loss function adopted for calculating the loss information may be a cross entropy loss function; and then, model parameters of the encoder and the decoder in the item processing model can be adjusted by model back propagation according to the loss information.
(2) Inference process of item processing model:

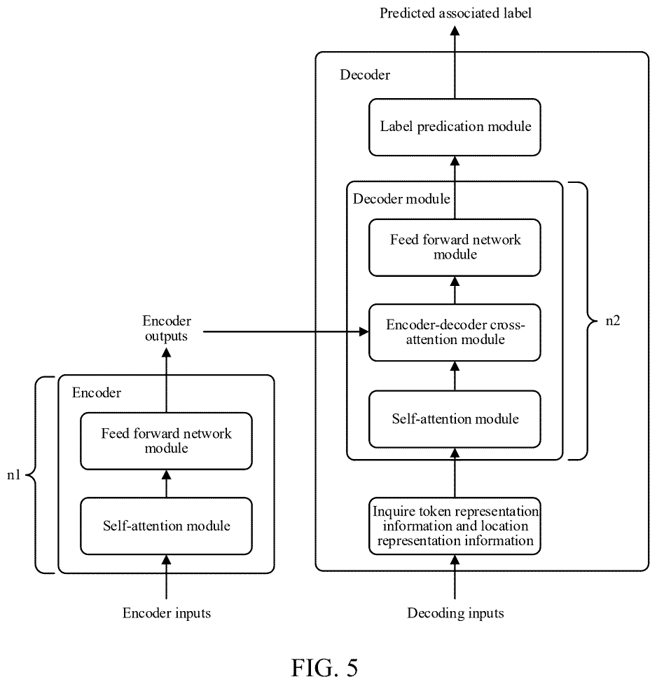

The item processing model adopts different frameworks in the training process and the inference process, after the item processing model is obtained by training, the item processing model is deployed in the inference framework (namely the model application inference framework); similar to the process of training the item processing model, and during the inference process of the item processing model, it is needed to transform the original large-scale generative language model into the classification model adapting to the item recommendation service. As shown in FIG. 5, during the inference process of the item processing model, the structure of the item processing model before modification under the model application inference framework may include:
(1) n1 Encoders: the n1 Encoders have the same structures, and the Encoders can be configured to encode encoder inputs. Further, any decoder may include a Self-Attention module and a Feed Forward Network module; the Self-Attention module can be configured to learn the degree of association among tokens in the encoder inputs; and the Feed Forward Network module can be configured to perform nonlinear mapping on the output result of the Self-Attention module and further learning the output result of the Self-Attention module.
(2) Decoder: the decoder may include n2 decoder modules and a label prediction module (beam search), the n2 decoder modules have the same structure; the decoder modules can be configured for decoding in combination with decoding inputs and encoder outputs of the n1 encoders; and the label prediction module (beam search) can be configured to perform associated label prediction based on decoding outputs of the n2 decoder modules to generate a predicted associated label. Further, any decoder module may include a self-attention module, an encoder-decoder cross-attention module and a feed forward network module; the self-attention module can be configured to learn a degree of association among tokens in the decoding inputs, the encoder-decoder cross-attention module can learn an association between the encoder inputs and the decoding inputs, and the feed forward network module can be configured to perform nonlinear mapping on output results of the encoder-decoder cross-attention module and further learn the output results of the encoder-decoder cross-attention module.

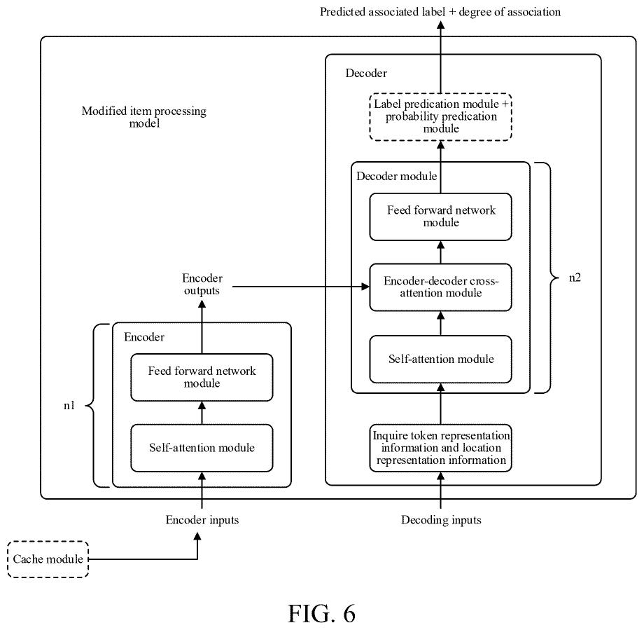

As shown in FIG. 6, the adaptive modification for the item processing model in the inference process is marked with a dashed box; the adaptive modification for the item processing model in the inference process may include: for the item processing model, an item processing model decoder only outputs a generated token (namely the predicted associated label) under a first architecture, and does not support the functions such as the classification model and outputting token probability (namely the degree of association under the predicted associated label). In order to be consistent with the modification for the item processing model in the training process, a probability prediction module (softmax) may be adopted to modify the label prediction module (beam search); after modification, the probability prediction module (softmax) and the label prediction module (beam search) are combined into a prediction module; a softmax value of an original token may be acquired as the token probability and outputted, namely output is [output id, output prob], where the output id is a predicted associated label, and the output prob is a degree of association under the predicted associated label.

By adaptive modification, the inference process of the item processing model may include: taking the target item as an example, where the encoder inputs of the item processing model are the prompt information of the target item, after being inputted into the item processing model, the prompt information of the target item is divided into a plurality of tokens, representation information of each token in the prompt information of the target item can be acquired, and the representation information of any token refers to a vector representation that can be configured for uniquely representing the token; calling an encoder under the model application inference framework to perform semantic analysis on each token based on an association between the representation information of each token, to obtain context semantic information of each token; calling the decoder module (specifically, the encoder-decoder cross-attention module and the feed forward network module of the decoder module) under the model application inference framework to generate decoded representation of the decoding inputs based on an association between the context semantic information of each token and the context semantic information of the decoding inputs (the context semantic information of the decoding inputs may be obtained through the self-attention module of the decoder module); and calling the prediction module under the model application inference framework to predict association on the service user and the target item based on the decoded representation of the decoding inputs, to obtain the degree of association of the service user with the target item.

More specifically, the process of calling the prediction module under the model application inference framework to predict association on the service user and the target item based on the decoded representation of the decoding inputs, to obtain the degree of association of the service user with the target item may include: calling a label prediction module in the prediction module under the model application inference framework to perform associated label prediction on the service user and the target item based on the decoded representation of the decoding inputs, to obtain the predicted associated label between the service user and the target item; calling a probability prediction module in the prediction module under the model application inference framework to perform association probability prediction on the service user and the target item based on the decoded representation of the decoding inputs, to obtain a plurality of candidate probabilities under the predicted associated label; and selecting the degree of association of the service user with the target item from the plurality of candidate probabilities, specifically, selecting the maximum candidate probability from the plurality of candidate probabilities as the degree of association of the service user with the target item.

In addition to structure modification of the item processing model during the inference process of the item processing model, in one embodiment of this application, an internal memory cache is optimized, the information of the service user in the prompt information, the features of the associated items and the features of the candidate items are subjected to representation caching, and the representation caching refers to caching the representation information of tokens in the service user, the features of the associated items and the features of the candidate items that have appeared; and when there are repeated tokens, the cached representation information can be directly used, instead of representation analysis again, so that the time consumed by encoding of the encoder in the item processing model is reduced. To be specific, in one embodiment of this application, a cache module is added prior to the encoder of the item processing model; for the item recommendation services, the material repository is preferential, and the information of the service users, the features of the associated users and the features of the candidate items in multiple requests of different service users may be repeated. Therefore, the representation information can be computed in advance according to the item features and the information of the service users, and the computing time of real-time representation analysis is decreased.

The process of mapping internal memory cache modification to each token in the prompt information of the target item and acquiring the representation information of each token in the prompt information of the target item may include: a representation information repository (namely the cache module) can be acquired, and the representation information repository includes representation information of a plurality of words (namely tokens that have appeared); the representation information of each token in the prompt information of the target item can be searched from the representation information repository; if a word matched with the first token in the prompt information of the target item is found in the representation information repository, the representation information of the matched word can be determined as the representation information of the first token; and representation analysis is performed on the second token other than the first token in the prompt information of the target item to obtain representation information of the second token. To be specific, in each token in the prompt information of the target item, the representation information of the token which has been subjected to representation analysis is cached in the cache module and can be directly acquired in the cache module, and the representation information of the token which has not been subjected to representation analysis does not exist in the cache module and needs to be subjected to representation analysis.

As described above, before the item processing model formally performs item recommendation online, the item processing model needs to undergo the model training stage and the model test stage, and after passing the model test, the item processing model can formally perform item recommendation online. The model test process of the item processing model is detailed as follows: the sample data may further include a test set configured for testing the item processing model obtained in training, the test set may include a plurality of test samples, and each test sample may include prompt information of the test item and a test associated label corresponding to the test item; the model performance of the item processing model can be evaluated based on the test set under the model training inference framework to obtain first evaluation information, and the model performance of the item processing model is evaluated based on the test set under the model application inference framework to obtain second evaluation information; if a difference between the first evaluation information and the second evaluation information is smaller than a difference threshold, it can be determined that the item processing model passes the test, and the item processing model can be called under the model application inference framework to predict association on the service user and each candidate item recalled for the service user; and if the difference between the first evaluation information and the second evaluation information is greater than or equal to the difference threshold, it can be determined that the item processing model does not pass the test, and it is needed to continuously adjust the item processing model.

The evaluation information (namely the first evaluation information and the second evaluation information) can specifically refer to estimated AUC values, the process of evaluating the model performance of the item processing model based on the test set under the model training inference framework is similar to the process of evaluating the model performance of the item processing model based on the test set under the model application inference framework, and the process of evaluating the model performance of the item processing model based on the test set under the model training inference framework is described herein and may specifically include: the test samples in the test set may include positive test samples and negative test samples, the positive test samples refer to test items that a test user is willing to access, and the negative test samples refer to test items that the test user refuses to access; the item processing model can be called under the model training inference framework to predict association on the test samples in the test set and a corresponding test user to obtain the predicted associated label; a first proportion of samples which are correctly determined to be positive in the positive test samples can be counted, the first proportion of samples may specifically be a ratio of the positive test samples which are correctly determined to be positive in the positive test samples to all the positive test samples; a second proportion of samples which are wrongly determined to be positive in the negative test samples can be counted, the second proportion of samples may specifically be a ratio of the negative test samples which are wrongly determined to be positive in the negative test samples to all the negative test samples; and then, the first evaluation information can be determined according to a ratio of the first proportion of samples to the second proportion of samples, and the positive refers to that the predicted associated label indicates that the test user is willing to access a corresponding test item.

S303: Perform service processing on the target item based on the degree of association of the service user with the target item.

In one embodiment, the target items may be classified according to the degree of association of the service user with the target items, thereby enabling different service processing for the target items classified into different categories for the service user. The service processing is processing under a specific service made for the service user and based on the target item, specifically, recommending the target item, determining not to recommend the target item, binding the target item with the service user or unbinding the target item from the service user, and the like.

In the service (i.e., the item recommendation service), when the service user accesses the service, the service provider can recall a plurality of candidate items for the service user, and can call the item processing model under the model application inference framework to predict association on the service user and each candidate item, to obtain the predicted associated label between the service user and each candidate item and the degree of association under the predicted associated label; the predicted associated label of any candidate item can be configured for indicating that the service user is willing to access the corresponding candidate item, or the service user refuses to access the corresponding candidate item. Further, in the candidate items recalled for the service user, intended candidate items whose predicted associated labels indicate the service user's willingness to access can be selected from the plurality of candidate items, then the intended candidate items can be ranked based on degree of associations of the intended candidate items, and intended candidate items ranked before the target positions in the intended candidate items can be used as the recommended items of the service user, so that the recommended items can be recommended to the service user.

To be specific, for the target item, performing service processing on the target item based on the degree of association of the service user with the target item may include the following: if the predicted associated label corresponding to the target item indicates that the service user is willing to access the target item, the ranking position of the target item in the intended candidate items can be checked, and if the ranking position of the target item in the intended candidate items is before the target position, the target item can be recommended as the recommended item to the service user; if the predicted associated label corresponding to the target item indicates that the service user refuses to access the target item, recommending the target item to the service user can be refused; and if the ranking position of the target item in the intended candidate items is the target position or behind the target position, recommending the target item to the service user can be refused.

In one embodiment of this application, the item processing model which is originally the large-scale generative language model is adaptively modified into the classification model that adopts to the item recommendation service, thus it is possible for the implementation of the large-scale generative language model in the item recommendation service. Moreover, the inference framework in the training stage and the inference framework in the application stage of the item processing model are separated, and the inference acceleration framework that can improve the processing speed of the item processing model is used in the inference stage of the item processing model, thus the item recommendation efficiency can be improved, improving the service processing efficiency. In addition, during the inference process of the item processing model, by caching the representation information of the token that have appeared in the prompt information, the representation information of the token can be directly acquired when the token appears repeatedly, eliminating the need to spend time on representation analysis. In this way, the model inference speed is further improved, the item recommendation efficiency is improved, and the service processing efficiency is improved.

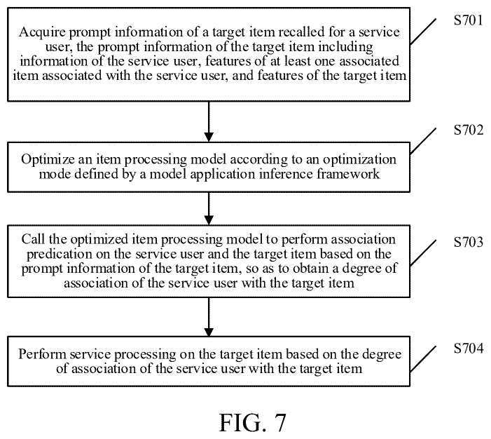

An embodiment of this application provides a service processing method; and in the service processing method, it involves an acceleration mode of the model application inference framework for the item processing model and a concurrent mechanism of the item processing model. The service processing method may be executed by the computer device, and the computer device may be, for example, the item recommendation device 102 in the service processing system shown in FIG. 1, or the computer device may be an integrated device of the recommendation request device 101 and the item recommendation device 102. As shown in FIG. 7, the service processing method may include, but is not limited to, the following operations S701-S704:

S701: Acquire prompt information of a target item recalled for a service user, the prompt information of the target item including information of the service user, features of at least one associated item associated with the service user, and features of the target item.

In one embodiment of this application, the execution process of operation S701 is the same as the execution process of operation S301 in one embodiment shown in FIG. 3, and the specific execution process can refer to the description of operation S301 in one embodiment shown in the FIG. 3 above, which will not be described here.

S702: Optimize the item processing model according to an optimization mode defined by the model application inference framework.

S703: Call the optimized item processing model to predict association on the service user and the target item based on the prompt information of the target item, to obtain a degree of association of the service user with the target item.

In operations S702-S703, as described above, a processing speed of the item processing model in the model application inference framework is higher than a processing speed of the item processing model in the model training inference framework due to the fact that the model application inference framework defines the optimization mode for the item processing model to predict association, and the item processing model can be optimized according to the optimization mode defined by the model application inference framework; and then, the optimized item processing model is called to predict association on the service user and the target item based on the prompt information of the target item to obtain the degree of association of the service user with the target item. Therefore, the efficiency of performing association prediction by the item processing model can be improved. The optimization mode of the model application inference framework is mainly embodied in any one or two of operator fusion and matrix computation optimization, and the optimization modes of the two model application inference frameworks are correspondingly described as follows:
(1) Operator fusion:

The association prediction logic of the item processing model may be implemented by mutual cooperation of operators of each layer in the item processing model; operators of each layer needs to call a kernel of a central processing unit (CPU) of the computer device for operation; and if the number of layers of operators in the item processing model is too large, it will consume a large amount of time to call the kernel and interaction between the kernels. Therefore, the operator fusion can be performed on operators of each layer in the item processing model. Specifically, the optimization mode of the model application inference framework may include a fusion mode between operators of each layer in the item processing model. In such case, optimizing the item processing model according to the optimization mode may include: performing fusion processing on operators of each layer of the item processing model according to the fusion mode; and the calling the optimized item processing model to predict association on the service user and the target item based on the prompt information of the target item, to obtain a degree of association of the service user with the target item may include: calling the fused item processing model to predict association on the service user and the target item based on the prompt information of the target item, to obtain the degree of association of the service user with the target item.

Further, the operators of each layer in the item processing model may include a matrix operation operator and a non-matrix operation operator, and matrix operation is core operation for performing association prediction by the item processing model, so the matrix operation operator needs a large amount of time to perform matrix operation. In this case, the performing fusion processing on operators of each layer of the item processing model according to the fusion mode may include: keeping the matrix operation operator unchanged, and performing fusion processing on the non-matrix operation operator.

Namely, according to one embodiment of this application, the fusion processing may be performed on some operators which needs little computation time in the item processing model, thus the time for theses operators to call the kernels and interaction between the kernels are reduced, improving the association prediction efficiency of the item processing model. In this way, the item recommendation efficiency can be improved, improving the service processing efficiency.
(2) Matrix computation optimization:

As described above, the matrix operation is the core operation for performing association prediction by the item processing model; the matrix operation consumes a lot of time in the association prediction process of the item processing model. Therefore, optimizing a matrix operation algorithm and improving the matrix operation speed can improve the association prediction efficiency of the item processing model. The optimization mode of the model application inference framework may include a matrix operation optimization mode of the matrix operation operators in the item processing model. In such case, optimizing the item processing model according to the optimization mode may include: optimizing the matrix operation algorithm of the matrix operation operator according to the matrix operation optimization mode. Namely, in one embodiment of this application, the matrix operation algorithm of the matrix operation operator in the item processing model can be optimized. In this way, a matrix operation speed of the matrix operation operator and the item recommendation efficiency can be improved, thereby improving the service processing efficiency.

S704: Perform service processing on the target item based on the degree of association of the service user with the target item.

In one embodiment of this application, the execution process of operation S704 is the same as the execution process of operation S303 in one embodiment shown in FIG. 3, and the specific execution process can refer to the description of operation S303 in one embodiment shown in the FIG. 3 above, which will not be described here.

Based on operations S701-S704 above, in order to further improve the item recommendation efficiency, in one embodiment of this application, it supports the concurrent mechanism, and the concurrent mechanism supported in one embodiment of this application may include any one of a first concurrent mechanism, a second concurrent mechanism and a third concurrent mechanism; the first concurrent mechanism refers to that association prediction is performed concurrently on a single service user and different candidate items, the second concurrent mechanism refers to that association prediction is performed concurrently on a single service user and candidate items in different service scenarios, and the third concurrent mechanism refers to that association prediction is performed concurrently on a plurality of service users. The following is an introduction to the different concurrent mechanisms supported by the embodiments of this application:
(1) First concurrent mechanism:

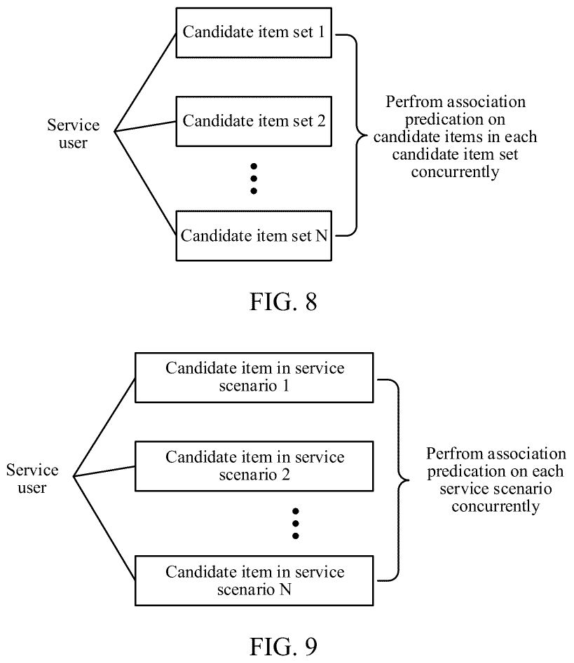

As shown in FIG. 8, the target item is any one of a plurality of candidate items recalled for the service user, the plurality of candidate items may be divided into N candidate item sets (candidate item set 1 to candidate item set N as shown in FIG. 8), and N is an integer greater than 1. In such case, the item processing model can be called under the model application inference framework to predict association on each candidate item set in the N candidate item sets in sequence; for each candidate item set, the item processing model can be called under the model application inference framework to predict association on the service user and each candidate item in the candidate item set concurrently, to obtain the degree of association of the service user with each candidate item in the candidate item set, namely, the process of association prediction on each candidate item in each candidate item set is concurrent. The service user and the candidate items in each candidate item set can form a request packet respectively, N request packets of “service user-candidate item set” are formed in total, each request packet requests the item processing model in parallel, and the item processing model processes the plurality of candidate items in the request packet in parallel.
By the first concurrent mechanism, the association prediction can be performed on a single service user and different candidate items concurrently instead of performing association prediction on a single service user and different candidate items in sequence. Therefore, the efficiency of recommending items to a single service user can be improved, thereby improving the service processing efficiency of a single service user.
(2) Second concurrent mechanism:

As shown in FIG. 9, the target item is any one of the plurality of candidate items recalled for the service user; the plurality of candidate items belong to N different service scenarios (service scenario 1 to service scenario N as shown in FIG. 9) of the same service, the number of the candidate items in the N service scenarios may be the same or different, and N is an integer greater than 1; and N item processing models are deployed under the model application inference framework, and the N item processing models are in one-to-one correspondence with the N service scenarios. In such case, the N item processing models can be called under the model application inference framework to predict association on the service user and each candidate item in a corresponding service scenario based on the prompt information of each candidate item in the corresponding service scenario, to obtain the degree of association of the service user with each candidate item in the corresponding service scenario; and processes of association prediction of the N item processing models are parallel. Namely, the service user and the candidate item in each service scenario can form a request packet respectively, N request packets of the “service user-candidate item under service scenario” are formed in total, the N item processing models are requested in parallel, and the N item processing models process the N request packets in parallel.

The N item processing models may be deployed in the same device or N different devices. When the N item processing models are deployed in the same device, each item processing model serves as an item processing service of the device, and the N item processing services process the N request packets in parallel. When the N item processing models are deployed in N different devices, the computer device is a distributed system composed of N devices, and the N devices process the N request packets in parallel in a distributed mode.

By the second concurrent mechanism, the association prediction can be performed on the single service user and the candidate items in different service scenarios concurrently, instead of sequentially performing association prediction on a single service user and the candidate items in each service scenario. Therefore, the efficiency of simultaneously performing item recommendation on a single service user in the plurality of service scenarios can be improved, thereby improving the service processing efficiency of the single service user.
(3) Third concurrent mechanism:

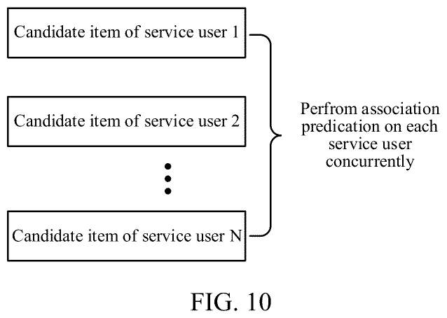

As shown in FIG. 10, the service provider recalls the candidate items for the N service users (service user 1 to service user N as shown in FIG. 10), and N is an integer greater than 1; and the N item processing models are deployed under the model application inference framework, and the N item processing models are in one-to-one correspondence with the N service users. In such case, the N item processing models can be called under the model application inference framework to predict association on the corresponding service users; and the processes of association prediction of the N item processing models are parallel. Namely, the N service users and the candidate item corresponding to each service user form a request packet respectively, N “service user-candidate item” request packets are formed in total, the N item processing models are requested in parallel, and the N item processing models process the N request packets in parallel.

The N item processing models may be deployed in the same device or N different devices. When the N item processing models are deployed in the same device, each item processing model serves as an item processing service of the device, and the N item processing services process the N request packets in parallel. When the N item processing models are deployed in N different devices, the computer device is a distributed system composed of N devices, and the N devices process the N request packets in parallel in a distributed mode.

By the third concurrent mechanism, item recommendation can be performed on the plurality of service users concurrently, instead of performing item recommendation on each service user in sequence, so that it supports simultaneous access of more service users for item recommendation, and the efficiency of item recommendation performed by the service provider for the plurality of service users can be improved.

In one embodiment of this application, the optimization mode for the item processing model to predict association is defined by the model application inference framework (including operator fusion and matrix computation optimization); after the item processing model is optimized according to the optimization mode defined by the model application inference framework, the optimized item processing model is called for association prediction. Therefore, the efficiency of association prediction of the item processing model, and the item recommendation efficiency can be improved, thereby improving the service processing efficiency. Moreover, based on the concurrent mechanism, in one embodiment of this application, the association prediction can be performed on a single service user and different candidate items, thereby improving the efficiency of item recommendation for a single service user; based on the concurrent mechanism, in one embodiment of this application, the association prediction can also be performed on a single service user and the candidate items in different service scenarios concurrently, thereby improving the efficiency of simultaneously performing item recommendation on the single service user in the plurality of service scenarios; and based on the concurrent mechanism, in one embodiment of this application, the item recommendation can also be performed on the plurality of service users concurrently. Therefore, the efficiency of simultaneously performing item recommendation on the plurality of service users by the service provider can be improved.

The method provided by one embodiment of this application is described above; and in order to facilitate the better implementation of the above solution of one embodiment of this application, an apparatus in one embodiment of this application is correspondingly provided below.

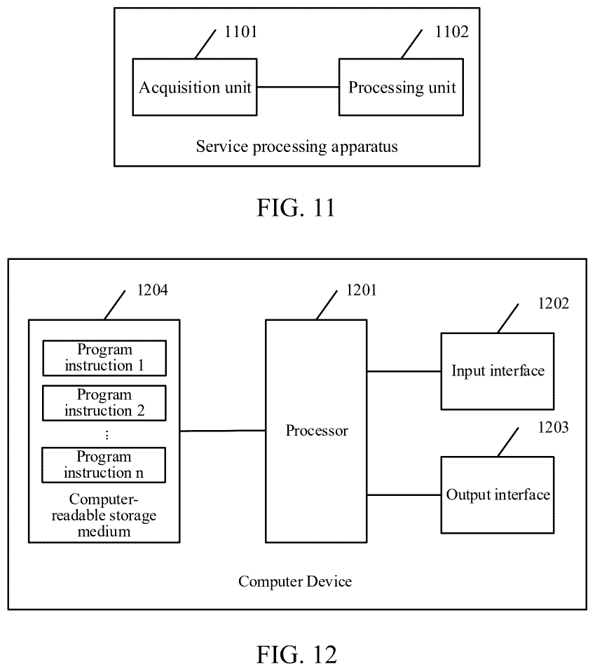

With reference to FIG. 11, FIG. 11 is a schematic structural diagram of a service processing apparatus provided by an embodiment of this application. The service processing apparatus may be arranged in the computer device provided by an embodiment of this application, and the computer device may be, for example, the item recommendation device 102 in the service processing system shown in FIG. 1, or the integration device of the recommendation request device 101 and the item recommendation device 102 in the service processing system shown in FIG. 1. The service processing apparatus shown in FIG. 11 may be a computer program running in the computer device, and the service processing apparatus can be configured to execute part or all operations in the method embodiment shown in FIG. 3 or FIG. 7. With reference to FIG. 11, the service processing apparatus may include following units:
an acquisition unit 1101, configured to acquire prompt information of a target item recalled for the service user, the prompt information of the target item including information of the service user, features of at least one associated item associated with the service user, and features of the target item; and
a processing unit 1102, configured to call the item processing model under a model application inference framework to predict a degree of association of the service user with the target item based on the prompt information of the target item, the item processing model being obtained by training under a model training inference framework and reused in the model application inference framework; a processing speed of the item processing model in the model application inference framework being higher than a processing speed of the item processing model in the model training inference framework; and
the processing unit 1102 being further configured to perform service processing on the target item based on the degree of association of the service user with the target item.

In one embodiment, the optimization mode for the item processing model to predict association is defined by the model application inference framework; when the processing unit 1102 is configured to call the item processing model under the model application inference framework to predict association on the service user and the target item based on the prompt information of the target item, to obtain the degree of association of the service user with the target item, specifically, it is configured to execute the following operations:
optimizing the item processing model according to the optimization mode; and
calling the optimized item processing model to predict association on the service user and the target item based on the prompt information of the target item, to obtain the degree of association of the service user with the target item.

In one embodiment, the optimization mode may include a fusion mode between operators of each layer in the item processing model;
when the processing unit 1102 is configured to optimize the item processing model according to the optimization mode, specifically, it is configured to execute the following operation:
performing fusion processing on operators of each layer of the item processing model according to the fusion mode; and
when the processing unit 1102 is configured to call the optimized item processing model to predict association on the service user and the target item based on the prompt information of the target item, to obtain the degree of association of the service user with the target item, specifically, it is configured to execute the following operation: calling the fused item processing model to predict association on the service user and the target item based on the prompt information of the target item, to obtain the degree of association of the service user with the target item.

In one embodiment, the optimization mode includes a matrix operation optimization mode of the matrix operation operators in the item processing model;
when the processing unit 1102 is configured to optimize the item processing model according to the optimization mode, specifically, it is configured to execute the following operation:
optimizing a matrix operation algorithm of the matrix operation operator according to the matrix operation optimization mode.

In one embodiment, the item processing model includes an encoder and a decoder; the decoder includes a decoder module and a prediction module; after being inputted into the item processing model, the prompt information of the target item is divided into a plurality of tokens; and when the processing unit 1102 is configured to call the item processing model under the model application inference framework to predict the degree of association of the service user with the target item based on the prompt information of the target item, specifically, it is configured to execute the following operations:
acquiring the representation information of each token in the prompt information of the target item; calling an encoder under the model application inference framework to perform semantic analysis on each token based on an association between the representation information of each token, to obtain context semantic information of each token; calling the decoder module under the model application inference framework to generate decoded representation of the decoding inputs based on an association between the context semantic information of each token and the context semantic information of the decoding inputs; and calling the prediction module under the model application inference framework to predict association on the service user and the target item based on the decoded representation of the decoding inputs, to obtain the degree of association of the service user with the target item.

In one embodiment, the prediction module is obtained by modifying the label prediction module by the probability prediction module; and when the processing unit 1102 is configured to call the prediction module under the model application inference framework to predict association on the service user and the target item based on the decoded representation of the decoding inputs, to obtain the degree of association of the service user with the target item, specifically, it is configured to execute the following operations:
calling a label prediction module under the model application inference framework to perform associated label prediction on the service user and the target item based on the decoded representation of the decoding inputs, to obtain the predicted associated label between the service user and the target item; calling a probability prediction module under the model application inference framework to perform association probability prediction on the service user and the target item based on the decoded representation of the decoding inputs, to obtain a plurality of candidate probabilities under the predicted associated label; and
selecting the degree of association of the service user with the target item from the plurality of candidate probabilities.

In one embodiment, when the processing unit 1102 is configured to acquire the representation information of each token in the prompt information of the target item, specifically, it is configured to execute the following operations: acquiring a representation information repository, the representation information repository including representation information of a plurality of words; searching the representation information of each token in the prompt information of the target item from the representation information repository; if a word matched with the first token in the prompt information of the target item is found in the representation information repository, determining the representation information of the matched word as the representation information of the first token; and performing representation analysis on a second token other than the first token in the prompt information of the target item to obtain representation information of the second token.

In one embodiment, the target item is any one of a plurality of candidate items recalled for the service user; the plurality of candidate items belong to N different service scenarios of the same service, and N is an integer greater than 1; N item processing models are deployed under the model application inference framework, and the N item processing models are in one-to-one correspondence with the N service scenarios;
the processing unit 1102 is also configured to execute the following operation: calling the N item processing models under the model application inference framework to predict association on the service user and each candidate item in a corresponding service scenario based on the prompt information of each candidate item in the corresponding service scenario, to obtain the degree of association of the service user with each candidate item in the corresponding service scenario, processes of association prediction of the N item processing models being parallel.

In one embodiment, the processing unit 1102 is also configured to execute the following operations: acquiring an initial processing model and sample data, the sample data including a training set and a test set; training the initial processing model based on the training set under the model inference framework to obtain the item processing model; evaluating model performance of the item processing model based on the test set under the model training inference framework to obtain first evaluation information; evaluating the model performance of the item processing model based on the test set under the model application inference framework to obtain second evaluation information; and calling, if a difference between the first evaluation information and the second evaluation information is smaller than a difference threshold, the item processing model under the model application inference framework to predict association on the service user and each candidate item recalled for the service user, the target item being any candidate item recalled for the service user.

In one embodiment, the test samples in the test set include positive test samples and negative test samples, the positive test samples refer test items that a test user is willing to access, and the negative test samples refer test items that the test user refuses to access; when the processing unit 1102 is configured to evaluate the model performance of the item processing model based on the test set under the model training inference framework to obtain first evaluation information, specifically, it is configured to execute the following operations:
calling the item processing model under the model training inference framework to predict association on the test samples in the test set and a corresponding test user to obtain the predicted associated label; counting a first proportion of samples which are correctly determined to be positive in the positive test samples; counting a second proportion of samples which are wrongly determined to be positive in the negative test samples; and determining the first evaluation information according to a ratio of the first proportion of samples to the second proportion of samples, the positive referring to that the predicted associated label indicates that the test user is willing to access the corresponding test item.

According to another embodiment of this application, the units in the service processing apparatus shown in FIG. 11 may be partially or fully combined into one or several other units, or one (some) of the units may be further split into functionally smaller units, to achieve the same operation without affecting the realization of the technical effects of the embodiments of this application. The above units are divided based on logical functions, and in practical applications, the functions of one unit may also be realized by a plurality of units, or the functions of the plurality of units are implemented by one unit. In other embodiments of this application, the service processing apparatus may also include other units, and in practical application, these functions are also be implemented with assistance from other units, and may be implemented by a plurality of units in cooperation.

According to another embodiment of this application, the service processing apparatus as shown in FIG. 11 can be constructed and the service processing method provided by one embodiment of this application can be implemented by running computer programs that can execute some or all of the operations involved in the method as shown in FIG. 3 or FIG. 7 in a general-purpose computing device such as a computer including processing elements like a central processing unit (CPU), random access storage media (RAM), and read-only storage media (ROM), and a storage element. The computer programs may be stored on, for example, a computer-readable storage medium, and loaded into and run on the above-mentioned computing devices by the computer-readable storage medium.

In one embodiment of this application, the target item is recalled for the service user; after the prompt information of the target item recalled for the service user is acquired, the item processing model can be called under the model application inference framework to perform association detection on the service user and the target item based on the prompt information of the target item, to obtain the degree of association of the service user with the target item, and service processing can be performed on the target item based on the degree of association of the service user with the target item; the item processing model can be obtained by training under the model training inference framework and reused in the model application inference framework; and the processing speed of the item processing model in the model application inference framework is higher than the processing speed of the item processing model in the model training inference framework. Clearly, the item processing model can be configured to perform service processing in service; the model application inference framework may be understood as the inference framework adopted by the item processing model in the model inference process; the model training inference framework may be understood as the training framework adopted by the item processing model in the model training process; and in one embodiment of this application, the training framework and the inference framework of the item processing model may be separated; and the inference acceleration framework that can improve the processing speed of the item processing model can be used in the inference stage of the item processing model, so that the service processing efficiency can be improved.

Based on the above method and apparatus embodiments, an embodiment of this application provides a computer device. With reference to FIG. 12, FIG. 12 is a schematic structural diagram of a computer device provided by an embodiment of this application. The computer device shown in FIG. 12 at least includes a processor 1201, an input interface 1202, an output interface 1203 and a computer-readable storage medium 1204. The processor 1201, the input interface 1202, the output interface 1203 and the computer-readable storage medium 1204 may be connected by buses or other ways.

The computer-readable storage medium 1204 may be stored in a memory of the computer device, the computer-readable storage medium 1204 is configured to store computer programs, the computer programs include computer instructions; and the processor 1201 is configured to execute the computer programs stored in the computer-readable storage medium 1204. The processor 1201 (or central processing unit (CPU)) is a computing core and control core of the computer device, which is adapted to implement the computer programs, specifically for loading and executing the computer programs to achieve corresponding method processes or corresponding functions.

An embodiment of this application also provides a computer-readable storage medium (memory). The computer-readable storage medium is a memory device in the computer device and is configured to store programs and data. The computer-readable storage medium here may include both a built-in storage medium in the computer device and an extended storage medium supported by the computer device. The computer-readable storage medium provides a storage space that stores an operating system of the computer device. In addition, this storage space also contains computer programs that are adapted to be loaded and executed by the processor. The computer-readable storage medium here may be a high-speed RAM memory or a non-volatile memory, such as at least one disk memory; and in some embodiments, it may be at least one computer-readable storage medium located away from the aforementioned processor.

The computer device may be, for example, the item recommendation device 102 in the service processing system shown in FIG. 1, or an integrated device of the recommendation request device 101 and the item recommendation device 102 in the service processing system shown in FIG. 1; in specific implementation, the processor 1201 can load and execute the computer program stored in the computer-readable storage medium 1204 to implement corresponding operations in the service processing method shown in FIG. 3 or FIG. 7 above. In specific implementation, the computer programs stored on the computer-readable storage medium 1204 are loaded by the processor 1201 and perform the following operations:
acquiring prompt information of a target item recalled for a service user, the prompt information of the target item including information of the service user, features of at least one associated item associated with the service user, and features of the target item;
calling an item processing model under a model application inference framework to predict a degree of association of the service user with the target item based on the prompt information of the target item, the item processing model being obtained by training under a model training inference framework and reused in the model application inference framework, and a processing speed of the item processing model in the model application inference framework being higher than a processing speed of the item processing model in the model training inference framework; and
performing service processing on the target item based on the degree of association of the service user with the target item.

In one embodiment, the optimization mode for the item processing model to predict association is defined by the model application inference framework; when the computer programs in the computer-readable storage medium 1204 are loaded and executed by the processor 1201 to implement calling the item processing model under the model application inference framework to predict the degree of association of the service user with the target item based on the prompt information of the target item, specifically, it is configured to execute following operations: optimizing the item processing model according to the optimization mode; and calling the optimized item processing model to predict association on the service user and the target item based on the prompt information of the target item, to obtain the degree of association of the service user with the target item.

In one embodiment, the optimization mode may include a fusion mode between operators of each layer in the item processing model;
when the computer programs in the computer-readable storage medium 1204 are loaded and executed by the processor 1201 to implement optimizing the item processing model according to the optimization mode, specifically, it is configured to execute the following operation: performing fusion processing on operators of each layer of the item processing model according to the fusion mode; and
when the computer programs in the computer-readable storage medium 1204 are loaded and executed by the processor 1201 to implement calling the optimized item processing model to predict association on the service user and the target item based on the prompt information of the target item, to obtain the degree of association of the service user with the target item, specifically, it is configured to execute the following operation:
calling the fused item processing model to predict association on the service user and the target item based on the prompt information of the target item, to obtain the degree of association of the service user with the target item.

In one embodiment, the optimization mode includes a matrix operation optimization mode of the matrix operation operators in the item processing model;
when the computer programs in the computer-readable storage medium 1204 are loaded and executed by the processor 1201 to implement optimizing the item processing model according to an optimization mode defined by the model application inference framework, specifically, it is configured to execute the following operation:
optimizing a matrix operation algorithm of the matrix operation operator according to the matrix operation optimization mode.

In one embodiment, the item processing model includes an encoder and a decoder; the decoder includes a decoder module and a prediction module; after being inputted into the item processing model, the prompt information of the target item is divided into a plurality of tokens; and when the computer programs in the computer-readable storage medium 1204 are loaded and executed by the processor 1201 to implement calling the item processing model under the model application inference framework to predict the degree of association of the service user with the target item based on the prompt information of the target item, specifically, it is configured to execute the following operations:
acquiring the representation information of each token in the prompt information of the target item; calling an encoder under the model application inference framework to perform semantic analysis on each token based on an association between the representation information of each token, to obtain context semantic information of each token; calling the decoder module under the model application inference framework to generate decoded representation of the decoding inputs based on an association between the context semantic information of each token and the context semantic information of the decoding inputs; and calling the prediction module under the model application inference framework to predict association on the service user and the target item based on the decoded representation of the decoding inputs, to obtain the degree of association of the service user with the target item.

In one embodiment, the prediction module is obtained by modifying the label prediction module by the probability prediction module; and when the computer programs in the computer-readable storage medium 1204 are loaded and executed by the processor 1201 to implement calling the prediction module under the model application inference framework to predict association on the service user and the target item based on the decoded representation of the decoding inputs, to obtain the degree of association of the service user with the target item, specifically, it is configured to execute the following operations:
calling the label prediction module under the model application inference framework to perform associated label prediction on the service user and the target item based on the decoded representation of decoding inputs, to obtain the predicted associated label between the service user and the target item; calling the probability prediction module under the model application inference framework to perform association probability prediction on the service user and the target item based on the decoded representation of the decoding inputs, to obtain a plurality of candidate probabilities under the predicted associated label; and selecting the degree of association of the service user with the target item from the plurality of candidate probabilities.

In one embodiment, when the computer programs in the computer-readable storage medium 1204 are loaded and executed by the processor 1201 to implement acquiring the representation information of each token in the prompt information of the target item, specifically, it is configured to execute the following operations:
acquiring a representation information repository, the representation information repository including representation information of a plurality of words; searching representation information of each token in the prompt information of the target item from the representation information repository; if a word matched with a first token in the prompt information of the target item is found in the representation information repository, determining the representation information of the matched word as the representation information of the first token; and performing representation analysis on a second token other than the first token in the prompt information of the target item to obtain representation information of the second token.

In one embodiment, the target item is any one of a plurality of candidate items recalled for the service user; the plurality of candidate items belong to N different service scenarios of the same service, and N is an integer greater than 1; N item processing models are deployed under the model application inference framework, and the N item processing models are in one-to-one correspondence with the N service scenarios;
the computer programs in the computer-readable storage medium 1204 are loaded and executed by the processor 1201 to implement the following operations:
calling the N item processing models under the model application inference framework to predict association on the service user and each candidate item in a corresponding service scenario based on the prompt information of each candidate item in the corresponding service scenario, to obtain the degree of association of the service user with each candidate item in the corresponding service scenario, processes of association prediction of the N item processing models being parallel.

In one embodiment, the computer programs in the computer-readable storage medium 1204 are loaded and executed by the processor 1201 to implement the following operations: acquiring an initial processing model and sample data, the sample data including a training set and a test set; training the initial processing model based on the training set under the model inference framework to obtain the item processing model; evaluating model performance of the item processing model based on the test set under the model training inference framework to obtain first evaluation information; evaluating the model performance of the item processing model based on the test set under the model application inference framework to obtain second evaluation information; and calling, if a difference between the first evaluation information and the second evaluation information is smaller than a difference threshold, the item processing model under the model application inference framework to predict association on the service user and each candidate item recalled for the service user, the target item being any candidate item recalled for the service user.

In one embodiment, the test samples in the test set include positive test samples and negative test samples, the positive test samples refer test items that a test user is willing to access, and the negative test samples refer test items that the test user refuses to access; when the computer programs in the computer-readable storage medium 1204 are loaded and executed by the processor 1201 to implement evaluating the model performance of the item processing model based on the test set under the model training inference framework to obtain first evaluation information, specifically, it is configured to execute the following operations: calling the item processing model under the model training inference framework to predict association on the test samples in the test set and a corresponding test user to obtain the predicted associated label; counting a first proportion of samples which are correctly determined to be positive in the positive test samples; counting a second proportion of samples which are wrongly determined to be positive in the negative test samples; and determining the first evaluation information according to a ratio of the first proportion of samples to the second proportion of samples, the positive referring to that the predicted associated label indicates that the test user is willing to access the corresponding test item.

In one embodiment of this application, the target item is recalled for the service user; after the prompt information of the target item recalled for the service user is acquired, the item processing model can be called under the model application inference framework to predict the degree of association of the service user with the target item based on the prompt information of the target item and perform service processing on the target item based on the degree of association of the service user with the target item, the item processing model can be obtained by training under the model training inference framework and reused in the model application inference framework; and the processing speed of the item processing model in the model application inference framework is higher than the processing speed of the item processing model in the model training inference framework. Clearly, the item processing model can be configured to perform service processing in service; the model application inference framework may be understood as the inference framework adopted by the item processing model in the model inference process; the model training inference framework may be understood as the training framework adopted by the item processing model in the model training process; and in one embodiment of this application, the training framework and the inference framework of the item processing model may be separated; and the inference acceleration framework that can improve the processing speed of the item processing model can be used in the inference stage of the item processing model, so that the service processing efficiency can be improved.

In an aspect, this application provides a computer program product, which includes computer programs, and the computer programs are stored in the computer-readable storage medium. A processor of a computer device reads the computer programs from the computer-readable storage medium, and the processor executes the computer programs, to cause the computer device to execute the service processing method provided by above various modes.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The above embodiments only express several embodiments of this application, and their descriptions are more specific and detailed, but cannot be understood as limiting the scope of the present disclosure patent. For a person of ordinary skill in the art, a number of variations and improvements can be made without departing from the conception of the present application, which fall within the scope of protection of the present application. Therefore, the scope of protection of the present disclosure shall be subject to the attached claims.

What is claimed is:

1. A service processing method, executed by a computer device, comprising:
acquiring prompt information of a target item recalled for a service user, the prompt information of the target item comprising information of the service user, features of at least one associated item associated with the service user, and features of the target item;
calling an item processing model under a model application inference framework to predict a degree of association of the service user with the target item based on the prompt information of the target item, the item processing model being obtained by training under a model training inference framework and reused in the model application inference framework, and a processing speed of the item processing model in the model application inference framework being higher than a processing speed of the item processing model in the model training inference framework; and
performing service processing on the target item based on the degree of association of the service user with the target item.

2. The method according to claim 1, wherein the model application inference framework defines an optimization mode for the item processing model to predict association; the calling an item processing model under a model application inference framework to predict a degree of association of the service user with the target item based on the prompt information of the target item comprises:
optimizing the item processing model according to the optimization mode; and
calling the optimized item processing model to predict association of the service user and the target item based on the prompt information of the target item, to obtain the degree of association of the service user with the target item.

3. The method according to claim 2, wherein the optimization mode comprises a fusion mode between operators of each layer in the item processing model;
the optimizing the item processing model according to the optimization mode comprises:
performing fusion processing on operators of each layer of the item processing model according to the fusion mode; and
the calling the optimized item processing model to predict association of the service user and the target item based on the prompt information of the target item, to obtain the degree of association of the service user with the target item comprises:
calling the fused item processing model to predict association on the service user and the target item based on the prompt information of the target item, to obtain the degree of association of the service user with the target item.

4. The method according to claim 2, wherein the optimization mode comprises a matrix operation optimization mode of matrix operation operators in the item processing model;
the optimizing the item processing model according to the optimization mode comprises:
optimizing a matrix operation algorithm of the matrix operation operators according to the matrix operation optimization mode.

5. The method according to claim 1, wherein the item processing model comprises an encoder and a decoder; the decoder comprises a decoder module and a prediction module; after being inputted into the item processing model, the prompt information of the target item is divided into a plurality of tokens; the calling an item processing model under a model application inference framework to predict a degree of association of the service user with the target item based on the prompt information of the target item comprises:
acquiring representation information of each token in the prompt information of the target item;
calling the encoder under the model application inference framework to perform semantic analysis on each token based on an association between the representation information of each token, to obtain context semantic information of each token;
calling the decoder module under the model application inference framework to generate decoded representation of decoding inputs based on an association between the context semantic information of each token and the context semantic information of the decoding inputs; and
calling the prediction module under the model application inference framework to predict association of the service user and the target item based on the decoded representation of the decoding inputs, to obtain the degree of association of the service user with the target item.

6. The method according to claim 5, wherein the probability prediction module is obtained by modifying a label prediction module by a probability prediction module; the calling the prediction module under the model application inference framework to predict association of the service user and the target item based on the decoded representation of the decoding inputs, to obtain the degree of association of the service user with the target item comprises:
calling the label prediction module under the model application inference framework to perform associated label prediction on the service user and the target item based on the decoded representation of the decoding inputs, to obtain a predicted associated label between the service user and the target item;
calling the probability prediction module under the model application inference framework to perform association probability prediction on the service user and the target item based on the decoded representation of the decoding inputs, to obtain a plurality of candidate probabilities under the predicted associated label; and
selecting the degree of association of the service user with the target item from the plurality of candidate probabilities.

7. The method according to claim 5, wherein the acquiring representation information of each token in the prompt information of the target item comprises:
acquiring a representation information repository, comprising representation information of a plurality of words;
searching the representation information of each token in the prompt information of the target item from the representation information repository;
if a word matched with a first token in the prompt information of the target item is found in the representation information repository, determining representation information of the matched word as representation information of the first token; and
performing representation analysis on a second token other than the first token in the prompt information of the target item to obtain representation information of the second token.

8. The method according to claim 1, wherein the target item is any one of a plurality of candidate items recalled for the service user; the plurality of candidate items belong to N different service scenarios of the same service, and N is an integer greater than 1; N item processing models are deployed under the model application inference framework, and the N item processing models are in one-to-one correspondence with the N service scenarios; and
the method further comprises:
calling the N item processing models under the model application inference framework to predict association of the service user and each candidate item in a corresponding service scenario based on prompt information of each candidate item in the corresponding service scenario, to obtain a degree of association of the service user with each candidate item in the corresponding service scenario,
processes of association prediction of the N item processing models being parallel.

9. The method according to claim 1, further comprising:
acquiring an initial processing model and sample data, the sample data comprising a training set and a test set;
training the initial processing model based on the training set under the model training inference framework to obtain the item processing model;
evaluating model performance of the item processing model based on the test set under the model training inference framework to obtain first evaluation information;
evaluating the model performance of the item processing model based on the test set under the model application inference framework to obtain second evaluation information; and
calling, if a difference between the first evaluation information and the second evaluation information is smaller than a difference threshold, the item processing model under the model application inference framework to predict association of the service user and each candidate item recalled for the service user, the target item being any candidate item recalled for the service user.

10. The method according to claim 9, wherein test samples in the test set comprise positive test samples and negative test samples, the positive test samples refer to test items that a test user is willing to access, and the negative test samples refer to test items that the test user refuses to access; the evaluating model performance of the item processing model based on the test set under the model training inference framework to obtain first evaluation information comprises:
calling the item processing model under the model training inference framework to predict association of the test samples in the test set and a corresponding test user to obtain the predicted associated label;
counting a first proportion of samples which are correctly determined to be positive in the positive test samples;
counting a second proportion of samples which are wrongly determined to be positive in the negative test samples; and
determining the first evaluation information according to a ratio of the first proportion of samples to the second proportion of samples,
the positive refers to that the predicted associated label indicates that the test user is willing to access a corresponding test item.

11. A computer device, comprising:
a processor, adapted to implement computer programs; and
a computer-readable storage medium, having the computer programs stored therein, the computer programs being adapted to be loaded and executed by the processor to implement a service processing method comprising:
acquiring prompt information of a target item recalled for a service user, the prompt information of the target item comprising information of the service user, features of at least one associated item associated with the service user, and features of the target item;
calling an item processing model under a model application inference framework to predict a degree of association of the service user with the target item based on the prompt information of the target item, the item processing model being obtained by training under a model training inference framework and reused in the model application inference framework, and a processing speed of the item processing model in the model application inference framework being higher than a processing speed of the item processing model in the model training inference framework; and
performing service processing on the target item based on the degree of association of the service user with the target item.

12. The computer device according to claim 11, wherein the model application inference framework defines an optimization mode for the item processing model to predict association; the calling an item processing model under a model application inference framework to predict a degree of association of the service user with the target item based on the prompt information of the target item comprises:
optimizing the item processing model according to the optimization mode; and
calling the optimized item processing model to predict association of the service user and the target item based on the prompt information of the target item, to obtain the degree of association of the service user with the target item.

13. The computer device according to claim 12, wherein the optimization mode comprises a fusion mode between operators of each layer in the item processing model;
the optimizing the item processing model according to the optimization mode comprises:
performing fusion processing on operators of each layer of the item processing model according to the fusion mode; and
the calling the optimized item processing model to predict association of the service user and the target item based on the prompt information of the target item, to obtain the degree of association of the service user with the target item comprises:
calling the fused item processing model to predict association on the service user and the target item based on the prompt information of the target item, to obtain the degree of association of the service user with the target item.

14. The computer device according to claim 12, wherein the optimization mode comprises a matrix operation optimization mode of matrix operation operators in the item processing model;
the optimizing the item processing model according to the optimization mode comprises:
optimizing a matrix operation algorithm of the matrix operation operators according to the matrix operation optimization mode.

15. The computer device according to claim 11, wherein the item processing model comprises an encoder and a decoder; the decoder comprises a decoder module and a prediction module; after being inputted into the item processing model, the prompt information of the target item is divided into a plurality of tokens; the calling an item processing model under a model application inference framework to predict a degree of association of the service user with the target item based on the prompt information of the target item comprises:
acquiring representation information of each token in the prompt information of the target item;
calling the encoder under the model application inference framework to perform semantic analysis on each token based on an association between the representation information of each token, to obtain context semantic information of each token;
calling the decoder module under the model application inference framework to generate decoded representation of decoding inputs based on an association between the context semantic information of each token and the context semantic information of the decoding inputs; and
calling the prediction module under the model application inference framework to predict association of the service user and the target item based on the decoded representation of the decoding inputs, to obtain the degree of association of the service user with the target item.

16. The computer device according to claim 15, wherein the probability prediction module is obtained by modifying a label prediction module by a probability prediction module; the calling the prediction module under the model application inference framework to predict association of the service user and the target item based on the decoded representation of the decoding inputs, to obtain the degree of association of the service user with the target item comprises:
calling the label prediction module under the model application inference framework to perform associated label prediction on the service user and the target item based on the decoded representation of the decoding inputs, to obtain a predicted associated label between the service user and the target item;
calling the probability prediction module under the model application inference framework to perform association probability prediction on the service user and the target item based on the decoded representation of the decoding inputs, to obtain a plurality of candidate probabilities under the predicted associated label; and
selecting the degree of association of the service user with the target item from the plurality of candidate probabilities.

17. The computer device according to claim 15, wherein the acquiring representation information of each token in the prompt information of the target item comprises:
acquiring a representation information repository, comprising representation information of a plurality of words;
searching the representation information of each token in the prompt information of the target item from the representation information repository;
if a word matched with a first token in the prompt information of the target item is found in the representation information repository, determining representation information of the matched word as representation information of the first token; and
performing representation analysis on a second token other than the first token in the prompt information of the target item to obtain representation information of the second token.

18. The computer device according to claim 11, wherein the target item is any one of a plurality of candidate items recalled for the service user; the plurality of candidate items belong to N different service scenarios of the same service, and N is an integer greater than 1; N item processing models are deployed under the model application inference framework, and the N item processing models are in one-to-one correspondence with the N service scenarios; and
the method further comprises:
calling the N item processing models under the model application inference framework to predict association of the service user and each candidate item in a corresponding service scenario based on prompt information of each candidate item in the corresponding service scenario, to obtain a degree of association of the service user with each candidate item in the corresponding service scenario,
processes of association prediction of the N item processing models being parallel.

19. A non-transitory computer-readable storage medium, having computer programs stored therein, the computer programs being adapted to be loaded and executed by the processor to implement a service processing method comprising:
acquiring prompt information of a target item recalled for a service user, the prompt information of the target item comprising information of the service user, features of at least one associated item associated with the service user, and features of the target item;
calling an item processing model under a model application inference framework to predict a degree of association of the service user with the target item based on the prompt information of the target item, the item processing model being obtained by training under a model training inference framework and reused in the model application inference framework, and a processing speed of the item processing model in the model application inference framework being higher than a processing speed of the item processing model in the model training inference framework; and
performing service processing on the target item based on the degree of association of the service user with the target item.

20. The computer-readable storage medium according to claim 19, wherein the model application inference framework defines an optimization mode for the item processing model to predict association; the calling an item processing model under a model application inference framework to predict a degree of association of the service user with the target item based on the prompt information of the target item comprises:
optimizing the item processing model according to the optimization mode; and
calling the optimized item processing model to predict association of the service user and the target item based on the prompt information of the target item, to obtain the degree of association of the service user with the target item.
